(19) United States
(12) Patent Application Publication
(10) Pub. No.: US 2022/0164897 A1
(43) Pub. Date: May 26, 2022

(54) Methods and Apparatus for Identifying and Connecting Musicians

(71) Applicant: Doyle E. Thomas, San Diego, CA (US)

(72) Inventor: Doyle E. Thomas, San Diego, CA (US)

(21) Appl. No.: 17/102,826

(22) Filed: Nov. 24, 2020

(51) Int. Cl. G06Q 50/00; G06F 3/0481

(52) U.S. Cl. CPC G06Q 50/01; G06F 3/0481

(57) ABSTRACT

Methods and apparatus for identifying and connecting musicians based on a set of user entered and peer-determined criteria for both the user and other musicians are disclosed.

### BACKGROUND

### (1) Technical Field

The presently disclosed methods and apparatus is related to computer-assisted methods and apparatus for connecting musicians of varying degrees of musical abilities, and more specifically to methods and apparatus that permit users and musicians to evaluate their own and others musical skill levels and allow users to find, meet, and collaborate with other musicians of similar abilities, musical tastes, and desires for playing.

### (2) Background

It is a longstanding desire for musicians to find other likeminded musicians with whom they can share their desire to make music. In the past, musicians would get to know each by living near each other, having mutual friends, playing in the same small venues, or through other social means. Relatively recently, social media and software applications (or “Apps”) have become available which assist musicians in finding other musicians and/or in finding playing opportunities (“gigs”). For example, an app named “Jambro” (available on the World Wide Web at www.jambro.co allows its users to join “a real-world community of musicians that regularly hosts jams and meetups to bring local communities together.” It essentially provides a list of events at which musicians may be interested in performing. Accordingly, Jambro connects musicians with opportunities to play. As described on its website, Jambro is an intuitive networking platform that gives modern musicians access to global music industry talent. Another similar application is named “BandFriend”. Bandfriend allows musicians to find other musicians with whom they might form a band. Musicians can post their profiles to find other musicians, and once found, Bandfriend facilitates communication with such other musicians.

Another application is named “GigTown”. GigTown is a music technology platform that connects local musicians, live music venues, and fans. Providing musicians with an opportunity to market themselves for free on a broader stage, GigTown brings musicians, venues and party planners together. GigTown provides an option for its users to search musician profiles. It allows its users to establish connections beyond the already established world of music. The GigTown app allows musicians to upload audio tracks, video performances and personal information, which besides helping them promote themselves, also connects them with other artists who share similar interests.

Another “app” is named “Musicr”. Musicr is designed to bring local musicians together for the love of music. Users of the Musicr app fill out a profile that showcases their interests and proficiency and the instruments that the users like to play. Musicians can then search for people with similar musical interests and connect with them, form a band together, practice with each other and also share music tricks and tips.

Another “app” is “Indaba Music”. Indaba Music is an online community that brings musicians, the general public publishers, and radio stations, together. It is a platform for new and old musicians alike to collaborate, work on music recordings, and interact with music professionals and fans alike. Users of the Indaba Music app can also add new tracks or work on existing ones in an attempt to create music with people all around the world who share similar musical interests.

The app “Sonicbids” is yet another application. Sonicbids is an interactive open space for musicians and promoters to help them get together, collaborate and come up with jam sessions and gigs. It also allows budding musicians to obtain more gigs, attain industry exposure, and network with other musicians. Sonicbids helps people to find talent on its platform, get in touch with musicians, and advertise playing opportunities. Additionally, independent musicians can also connect with promoters and a music-loving audience to expand their music careers.

As is evident from a brief review of the above-described apps, a number of apps are currently available that assist budding and expert musicians alike to connect with others of similar expertise and musical interest. However, none of the applications allows a user to provide a self-evaluation of his or her musical skill level. Further, none of the applications also allow other musicians to provide a peer-evaluated musical skill level in accordance with the user's musical skill level.

Therefore, there is a need for methods and apparatus for identifying and connecting musicians of varying musician-ship levels and interests including a means for a user to provide a self-evaluated musical skill level while also including a means for other musicians to provide a peer-reviewed level of the user's musical skill level. There is also a need for methods and apparatus for identifying and connecting musicians of diverse musical skill levels to allow booking agents, venue agents and owners to share information and facilitate making connections. This feature facilitates use of venues controlled by such agents, if users that are matched with other musicians want to rehearse or perform together in such venues. The present methods and apparatus satisfy the above-described needs.

### SUMMARY

Methods and apparatus are disclosed that permit users and musicians to evaluate their own and others musical skill levels and allowing users to find, meet, and collaborate with other musicians of similar abilities, musical tastes, and desires for playing. The methods and apparatus allow musician/users to enter identifying information and other information regarding the user's musical interests and tastes, self-evaluated musical skill levels on different instruments, desires for jamming (or rehearsing, or forming a band, for example), etc. Other users may also enter peer-reviewed musical skill levels for the user which may or may not differ from the user's self-evaluated musical skill levels. When desired the user can command the presently disclosed methods and apparatus to perform one or more searches, or one or more matches, in accordance with the user's requirements and desires. Upon command, additional searches and matches can be performed should the user desire that a broader or narrower search/match be performed.

In some embodiments, the methods and apparatus include a user device comprising a User Interface Module, a Search Module, a Jam Management Module (JMM) or tool, a Profile Module, a Wireless Communication Interface Module, and a Display Module. In other embodiments, the methods and apparatus comprise a User Interface Module, one or more data processing/interactive devices, a display, a web server, and an internet cloud. In some such embodiments, the web server is accessible by both the user and other users. In other embodiments, the methods and apparatus also includes a Gig Arrangements module. The Gig Arrangements module may, in some embodiments, determine various rehearsal, gig, and other various musician-related gatherings at the user's request. The Gig Arrangements Module communicates information provided by the other modules and possible gig and various other musician playing possibilities to the user via the User Interface Module.

In some embodiments, the methods and apparatus also include an External Data Management and Processing Module and external system processor(s). In these embodiments, the External Data Management and Processing Module communicates with an Internet Cloud and with the external system processor(s). A Display Module displays results (such as search results or user matching results) on a display which is accessible to the user.

A method for searching for other musicians with whom to jam is also disclosed herein. After entering user identification information, the user also provides a self-evaluation of the level of his skill at playing various instruments. The disclosed methods and apparatus also receive peer-evaluated musical skill level(s) for the user as input provided by other users of the methods and apparatus. A search or match function is implemented based upon the user's input and the peer-reviewed level(s) input. The search generates results that are viewable by the user (typically on the user's display screen). The method then awaits further data entry by the user or other users.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a simplified block diagram of a system that can assist in the formation and development of relationships between different musicians and between musicians and managers of venues in which musicians might play music, including both rehearsal spaces and performance spaces.

FIG. 2 is a simplified functional block diagram of a user device that can be used in practicing the presently disclosed methods and apparatus.

FIG. 3 shows a “screenshot” showing what a user might see displayed on the user's display in accordance with some embodiments of the disclosed methods and apparatus.

FIG. 4 shows another screenshot showing what a user might see displayed on the user's display in accordance with some embodiments of the disclosed methods and apparatus.

FIG. 5 shows another screenshot that may be used to practice the presently disclosed methods and apparatus.

FIG. 6 is a simplified block diagram of another embodiment of a system for assisting in the formation and development of relationships between different musicians and between musicians and managers of venues in which musicians might play music.

FIG. 7 shows a simplified block diagram showing execution modules designed to implement the presently disclosed methods and apparatus of FIGS. 1 and 2.

FIG. 8 shows yet another embodiment of a system designed to implement the presently disclosed methods and apparatus.

FIG. 9 is a flow diagram of a method used to implement the presently disclosed methods and apparatus permitting users and musicians to evaluate their own and others musical skill levels.

Like reference numbers and designations in the various drawings indicate like elements.

### DETAILED DESCRIPTION

Aspects of the present disclosure relate to methods and apparatus for (1) establishing relationships between musicians, (2) sharing information, and (3) coordinating rehearsals and performances. Details of some disclosed embodiments are described below with reference to the accompanying figures.

The disclosed methods and apparatus are designed to make it easy for users having a diverse range of musical skill levels to connect with others (including but not limited to other musicians). In some embodiments, a user's musical skill level is used as one of several criteria upon which a match with other users is made. As described below in more detail, the user provides a self-evaluated musical skill level based on what he thinks is appropriate for his musical skill level. The user's musical skill level is also evaluated by other musicians/users and a consensus peer-reviewed skill level is also provided based upon the evaluation provided by the other musicians/users.

The methods and apparatus are designed to match users/musicians that fall into different musical skill level categories, as follows:

Accomplished musicians—musicians who can successfully play with others, but generally do not currently play with others; there are also accomplished musicians who want to regularly jam out in a public venue; and

Beginners/intermediate musicians—these are musicians who desire to play with other musicians, possibly to become accomplished musicians, or just for the joy of playing with others; and

Semi-Pro/Professional musicians—these are musicians who want to play in public venues and prefer to be paid for their efforts.

Many accomplished musicians do not play with others because they the time to do so, or because they do not wish to tolerate the inevitable complications that come from playing music with others. In general, it is difficult to find compatible musical partners. Musician matching apps or websites designed for musicians seeking other musicians are usually for people who desire to start a band, and eventually to be paid to play their music. Many accomplished musicians do not want to start a band. Often accomplished musicians have pursued starting a band one or more times and have generally decided to avoid jamming because of the inevitable difficulties presented by their prior pursuits. Even when people share the same goals, it is difficult to establish a symbiotic relationship. The present methods and apparatus are designed to make searching for other musicians easier, the results of which provide connections between musicians that are more compatible, and to make coordinating jams as simple as possible.

Although the disclosed methods and apparatus are useful to musicians at every level of musical skill, one target audience is the beginner or intermediate musician. This typically includes people who want to play an instrument or sing, but may not yet have honed their musical skills. Some of these people may have a musical instrument and want to participate in making a joyous musical sound, but who are not sure they want to expose their skill level to musicians of higher skill levels and are unsure of the process involved in participating in or setting up a jam session (i.e., playing with other musicians). The present methods and apparatus allow users to search for compatible musicians and connect with each other. The methods and apparatus provide tools to organize and run a jam and to grow as an individual musician and when playing with jam mates.

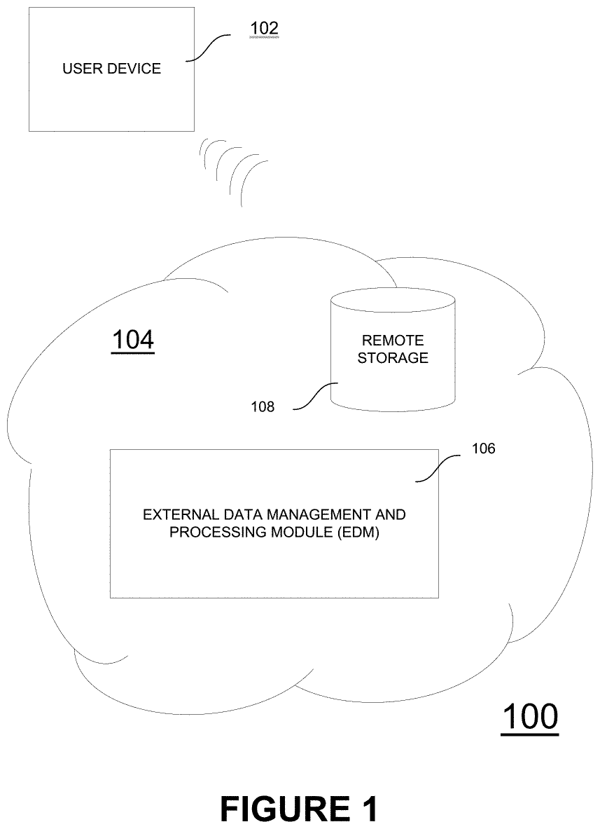

FIG. 1 is a simplified block diagram 100 of a system for assisting in the formation and development of relationships between different musicians and between musicians and managers of venues in which musicians might play music, including both rehearsal spaces and performance spaces. As shown in FIG. 1, in some embodiments, the system 100 includes a user device 102 that has the ability to connect wirelessly to an internet “cloud” 104. The cloud 104 has resources that may be accessed by the user device 102 (e.g., other devices to which the user device 102 can communicate via a wireless network, such as 5G, 4G, LTE, etc.). In some embodiments, the cloud 104 includes resources such as an External Data Management and Processing Module (EDM) 106 and a remote storage device 108. In some embodiments, the EDM 106 comprises software programming facilitating the matching of a user/musician with other musicians and/or performance/rehearsal space providers.

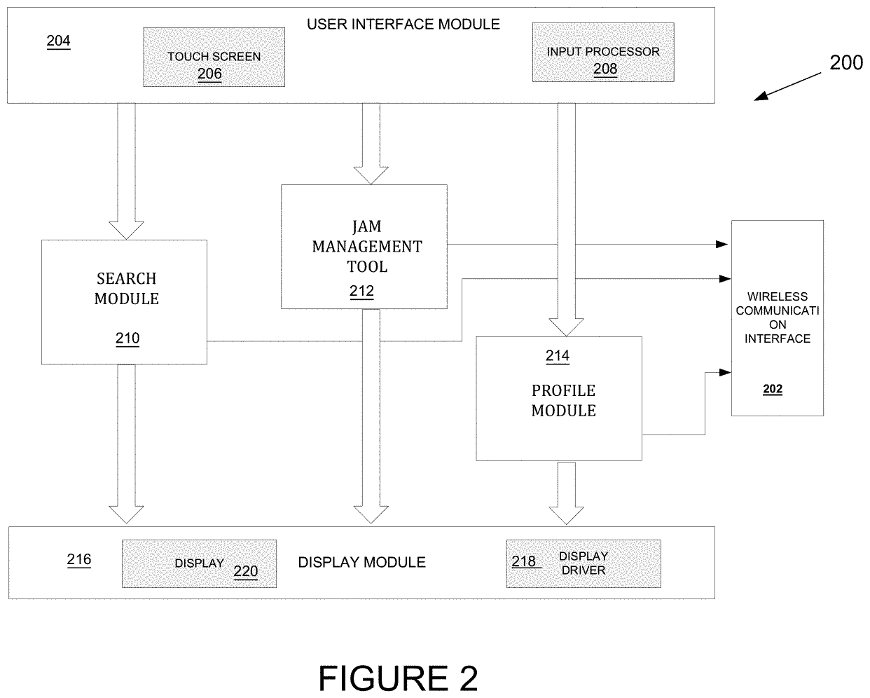

FIG. 2 is a simplified functional block diagram of a user device 200 (such as the user device 102 shown in FIG. 1). The user device 200 assists in establishing relationships between musicians, sharing of information between musicians, sharing information with managers of events and coordinating rehearsals and performances. In some embodiments, the user device 200 is a smart phone, tablet, personal computer or other such well known computing device. In some such embodiments, the user device has an internal wireless transceiver or Wireless Communication Interface Module 202 and is capable of wirelessly communicating with external devices, such as the EDM 106 and the remote storage device 108 of FIG. 1. As shown in FIG. 2, in some embodiments, the user device 200 comprises a User Interface Module 204 which may comprise a touch screen 206 and input processor 208.

In some embodiments, the user device 200 further comprises a Search Module 210, JMM 212, a Profile Module 214, and a Display Module 216. The Display Module 216 includes a display driver 218 and a display 220. As noted above, in some embodiments of the user device 200, the User Interface Module 204 comprises a user input device, such as a touch screen 206. In other embodiments, the User Input Module 204 may comprise a keyboard, a keypad, a voice activated input device, a mouse, etc. It will be clear to those skilled in the art that any means for conveying user data from the user to the User Interface Module 204 falls within the scope of the present disclosure. In addition, as shown in FIG. 2, in some embodiments the User Interface Module 204 further comprises an input processor 208. The input processor 208 may be a module that shares resources with other modules of the user device 200, including the modules expressly disclosed in this disclosure or modules that are unrelated to the functionality disclosed herein. The modules unrelated to the functionality disclosed herein are not shown for the sake of simplicity and to maintain the focus on the key aspects of the disclosed methods and apparatus.

As noted above, in some embodiments, the Display Module 216 comprises a display 220 on which information can be conveyed to the user. In some such embodiments, the display 220 may also serve as the user input device, such as when a touch screen is used as both the user input device and the display. In some embodiments the Display Module 216 further includes a display driver 218. In some cases, the display driver 218 may be integrated into the display 220.

(a) In some embodiments, the Profile Module 214, (b) Search Module 210, and (c) JMM 212 may be implemented by software that is executed and run entirely within the user device 200 (such as is shown in the embodiment of FIG. 2). In other embodiments, the Profile Module 214, Search Module 210 and JMM 212 are implemented by software that is executed on an external device. In still further embodiments, one or more of these 210, 212, 214 may be implemented by software that is executed within the user device 200 and on an external device. It will be appreciated by those in the software and electronic device arts that any and all of these embodiments fall within the scope of the present disclosure. The Profile Module 214, Search Module 210, and JMM 212 are now described in more detail.

### Profile Module

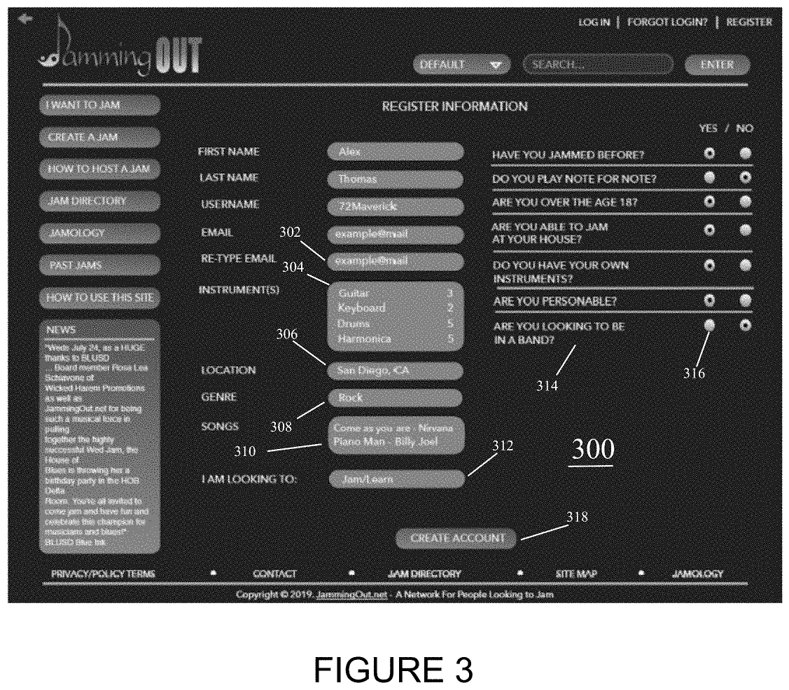

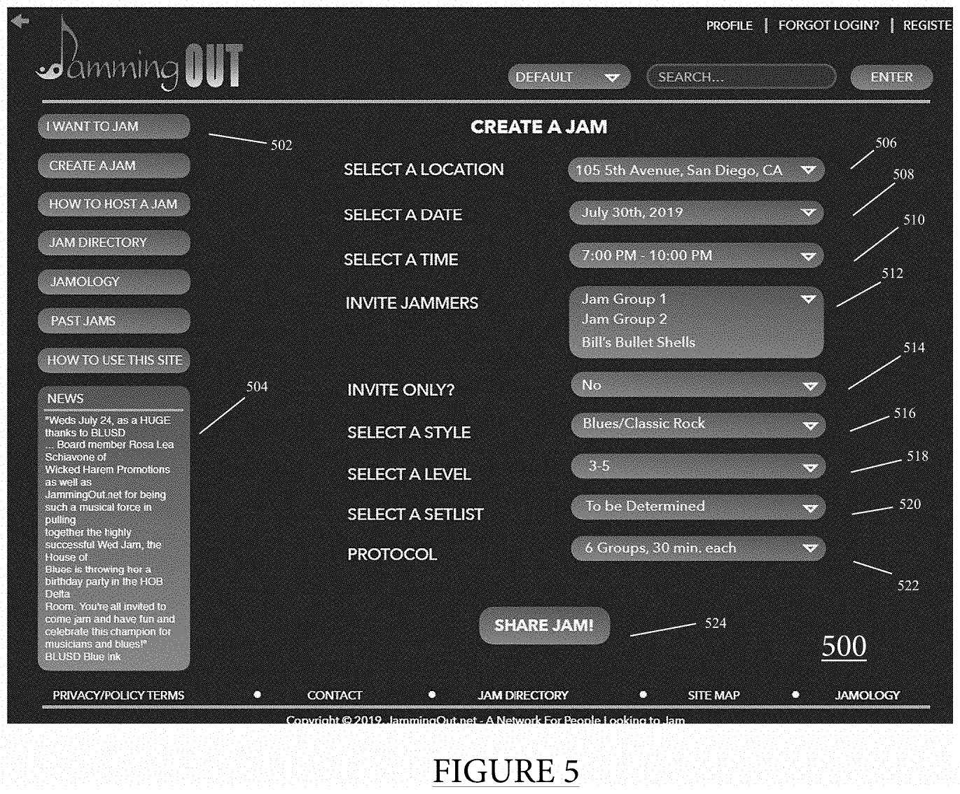

In some embodiments, the Profile Module 214 receives information from the User Interface Module 204. Once the user enters his profile with the Profile Module 214, the Search Module 210 and JMM 212 may be used to accomplish the user's goals (such as creating a jam session as shown in the screenshot of FIG. 5). The methods and apparatus comprise three main modules: the Search Module, for finding like-minded people and for connecting the user with like-minded people and users; a JMM 212 for managing an actual Jam as set up by the user; and the Profile Module for entering the user's information for use in communicating with other users. As described above with reference to the screenshot of FIG. 3, the Profile Module is used by the disclosed apparatus and methods to allow the user to provide user information and standard registration info, such as an email address, etc. Using this Profile Module, the user defines the user's musical experience by listing the instruments the user plays with a self-described and self-evaluated rating regarding the user's musical performance proficiency. The user fills out a survey that will represent the user's musical proclivity/tastes/preferences to include genre and style of songs with the ability to specify specific artists and songs.

The user enters information that the user considers relevant and useful in order to establish connections with other musicians and or promoters. In some embodiments, the Profile Module 214 creates graphics that are displayed by the Display Module 216. The Profile Module 214 also assists in creating a description or profile of the user that comprises, among other user characteristics, the user's musically related goals, the user's musical skill levels, and the user's musical interests or musical tastes.

In some embodiments, there are several pieces of information that the Profile Module 214 requests and receives from the user in order to create the user's “profile”. For example, FIG. 3 shows a “screenshot” 300 of what a user might see displayed on the display 220 in accordance with one embodiment of the disclosed methods and apparatus. In some embodiments, the display driver 218 is responsible for setting the format of the displayed information, but the Profile Module 214 provides the content to be displayed. Alternatively, in other embodiments, the Profile Module 214 is responsible for the entire graphical representation that is used to communicate and display the information regarding the user's profile to the user. That is, in some embodiments, a graphics generator within the Profile Module 214 creates the image that is presented to the Display Module 216 to be shown on the display 220.

Referring now to the screenshot 300 of FIG. 3, in some embodiments several pieces of core registration information are provided by the user in fields that are presented in a registration screen on the display 220. For example, the user enters his or her first name, last name, and an arbitrary unique username which the user can chose (in some embodiments the username cannot already be in use by another user, and if it is, the user must select a different username). In addition, the user enters the user's e-mail address. Because the e-mail address is important for establishing the communication connection between the system and the user, some embodiments have a second user e-mail field 302 in which the user re-enters the user's e-mail to confirm that it has been entered correctly.

In some embodiments, the user can “pull down” a “drop-down” menu (not shown) from which the user can indicate one or more musical instruments to be added to an instrument field 304 within the user's profile. In addition, a location field 306 is provided in which the user's central location can be entered. In some embodiments, the user's central location is a geographical point that is used as the point from which distance is measured to venues, such as rehearsal studios, show venues, and the central location of other musicians. Another field 308 is provided for entering the user's musical genre preference, such as classical, rock, blues, rap, etc. In some embodiments, a field 310 is provided in which the user can enter the names of songs (and possibly artists) that the user would like to play or that the user already knows how to play. In addition, a goals or interests field 312 is provided in which the user can enter information to indicate what the user is looking for, such as to just play with other musicians (jam), learn from other musicians, find bandmates, get bookings for a band that the user is already in, etc. These selections can either be entered using a pull-down menu or entered free-style (i.e., in response to the user typing or otherwise indicating the content to be placed in the field 312).

In addition to other fields 314 in which the user enters information that is typically unique to the user, a series of questions are displayed on the registration screen. These questions can be answered using “radio buttons” 316 to answer either yes or no. A list of questions that serve as an example in some embodiments are presented in FIG. 3. The questions presented in field 314 of FIG. 3 are provided merely as examples only for purposes of describing the present methods and apparatus. It will be recognized by those in the computer graphics and the musical arts that additional or fewer questions can be asked of the user, and that they may differ from those shown in the embodiment screen shot of FIG. 3.

Referring again to FIG. 3, the questions shown in the field 314 allow the user profile to reflect the user's nature and character. For example, the user's answers to questions such as, for example, whether the user can play “note for note”, provide information to other users and to the disclosed methods and apparatus that can assist in matching a user to other users based on similarities in the profiles of all users. Having entered the registration information on the registration screen 300, an indication 318 is provided that the user account (and so the user profile) should be created. In some embodiments, the user clicks the button 318 on the registration screen to indicate that the user is ready to create the account.

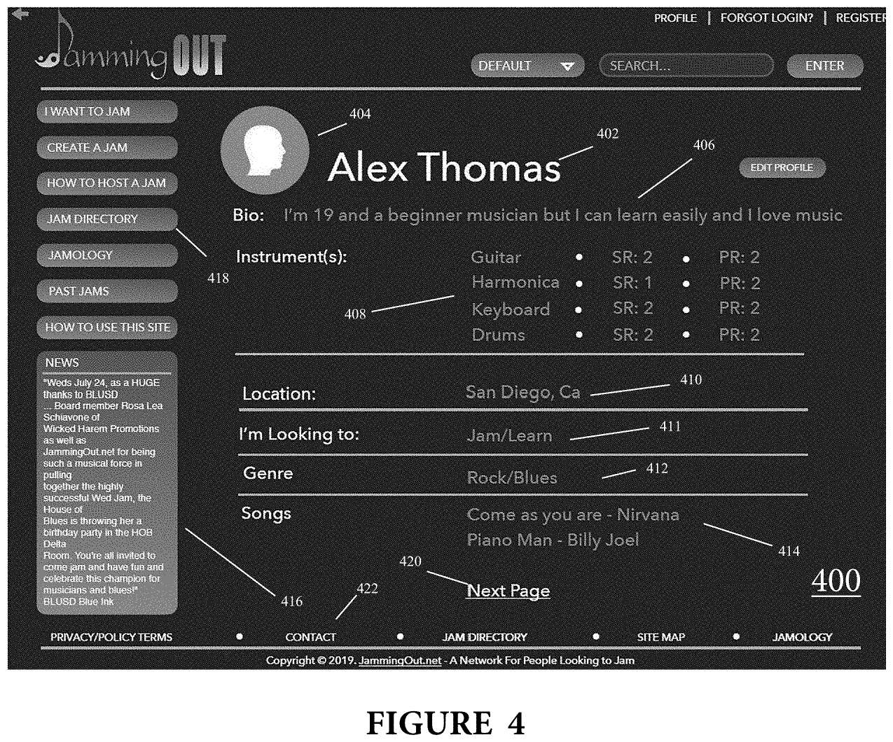

In some embodiments, other screenshots are created by the present methods and apparatus and displayed to the user. For example, FIG. 4 shows a screenshot 400 of what a user might see displayed on the display 220 in accordance with one embodiment of the disclosed methods and apparatus. The screenshot of FIG. 4 includes the user's name field 402), a picture field 404 in which a picture of the user can be shown, and a short bio field 406. The method might also have a field 408 that shows the instruments the user plays (such as guitar, harmonica, etc.), a field 410 with his location, a field 411 indicating his goals and his desires regarding what he′d like to do (e.g., Jam, Learn, etc.), a field 412 with the genre of music he is interested in (e.g., Rock, or blues), and a field 414 for entering the songs he knows how to play. The display 220 may also include, in some embodiments, a field for news information 416 as shown in the lower left hand corner of the screenshot 400. In some embodiments, this news field 416 contains news relevant to the user's expressed interests, in some embodiments, to musical performance in general.

It may also include buttons 418 leading to other information as shown on the left hand side, including but not limited to the following: “I WANT TO JAM”; “CREATE A JAM”; “HOW TO HOST A JAM”; “JAM DIRECTORY”; “JAMOLOGY”, “PAST JAMS”; and “HOW TO USE THIS SITE”. Additional buttons may also be included and they fall within the scope of the present disclosure and the appended claims. A “Next Page” button 420 is also included to lead the user to another page (i.e., another screensho). Also, as shown in the screenshot 400 of FIG. 4, the screenshot 400 may also include executable buttons 422 such as “CONTACT”, “JAM DIRECTORY”; “SITE MAP”, and “JAMOLOGY” which, when pressed, lead to further screens containing different information available for the user's use.

FIG. 5 shows another screenshot 500 used in some embodiments of the presently disclosed methods and apparatus. As described above with reference to the screenshots of FIGS. 3 and 4, the left side includes “buttons” 502 that execute certain function such as “I WANT TO JAM”, “CREATE A JAM”; “HOW TO HOST A JAM”, etc. As in the screenshots of FIGS. 3 and 4, there is also a “news” field 504 presenting news that the user may be interested in based on the user's profile. The screenshot of FIG. 5 may be displayed when the user decides to create a Jam. The user enters information that is pertinent to the Jam to be played. For example, the user may enter a location for the jam in a location field 506, a date in a date field 508, a time for the jam in a jam time field 510, etc. The user can invite other users to the jam session through an invite field 512. A drop down menu 514 may be provided wherein the user can select yes or no to “invite only”. The user can enter a style of music for the jam in a style field 516, and a user level desired by the user for use in the jam session in the level field 518. The user can select a set list to be played in a setlist field 520, and a protocol under which the jam session is to be operated (for example, the jam may be for 6 groups, each playing 30 minutes per group) in a protocol field 522. Once this information is entered by the user, the user can then press the “SHARE JAM” button 524 which then presents the desired jam session information to the presently disclosed methods and apparatus, and more importantly, to other users of the disclosed methods and apparatus.

The information provided to and by the Profile Module populates database elements that are used in search algorithms. The Profile Module also includes an intuitive experience for the user for discovery learning and will assist the user in formulating and realizing the user's personal musical performance goals.

### Search Module

In some embodiments, the disclosed apparatus and method includes a Search Module 210. In some embodiments, the Search Module 210 includes a database application (not shown) that uses custom queries to find matching or complementary musicians/artists with similar goals based on the user's profile. Search results are presented in a unique format that makes it easy to sort and find people and events, and to communicate with the presently disclosed methods and apparatus in order to find and connect with other jammers.

In some embodiments, the Search Module 210 includes a function to name each search that is performed by the disclosed methods and apparatus, making it easy to retrieve a particular search result. Upon completion of a search the user can annotate preferred contacts, then by pressing or contacting a single button the disclosed methods and apparatus will generate a group communication that will begin a thread similar to a group email. At this point, the user's goals and intentions/desires are described. Options are available for many combinations of contacts with other users. The Profile Module 214 and Search Module 210 facilitate the creation of jam sessions, and notification of jammers of any changes, for example. The current state of the art is to make phone calls, emails, texts resulting in the proverbial phone tags. The present methods and apparatus easily avoid such disadvantageous techniques. In some embodiments, the Search Module 210 launches a scheduling module.

### Jam Management Module (JMM)

The JMM 212 creates events based on the search results and user communications. Alternatively, the user can create a custom jam session. The JMM 212 will, in that case, notify other users of the creation of jam sessions. Such notifications are sent based on the information the user entered into the Profile Module 214 and information the other users have entered into Profile Modules 214 to which they have access. A jam can be created using a single button touch. For example, referring to the screenshot of FIG. 5, the user can easily create a desired jam session by pressing the button “SHARE JAM”. In some embodiments, the JMM includes the location of the venue, jam time, type of jam, participants, formatted for the type of jam selected (for example, a bar jam), the composition of jam, set list and when the jam will occur. Lyrics of songs and notes might also be included by the JMM. This module might have different musical skill levels from a beginner's garage jam up to and including a professional musical skill level. The JMM brings the traditionally pencil/paper managed jam into the digital age.

In some embodiments, the presently disclosed methods and apparatus also include a Stage Manager Version of the JMM 212. This version of the JMM would be used by the venue owners and other similar type users (i.e., venue agents, etc.). The Stage Manager Version allows venue owners and agents to set up Jams with the users, reserve times and places, collect payments, etc.

### Skill Levels

In some embodiments of the presently disclosed methods and apparatus, musicians are rated or ranked in accordance with their musical skill levels. The particular criteria may be objective, such as whether the user can play a full song from memory, the number of songs the user can play from memory, whether the user has played in a band before, whether the user has played in front of an audience, etc. As noted above, the user will be able to self-evaluate and enter a self-evaluated musical skill level into the presently disclosed methods and apparatus. The disclosed methods and apparatus will also allow users to be rated or ranked by their peers (i.e., musicians that have played with or that know the user). There will be no place or space allocated for derogatory remarks or personal attacks. Some users will only be allowed to enter a peer-reviewed musical skill evaluation level for a particular user. In some embodiments, if no peer-evaluated musical skill level is provided for a particular user, the disclosed methods and apparatus indicates that no value has been provided yet. Alternatively, in some embodiments a default value can be entered (e.g., level to 3 on a scale of 1-5). Alternatively, in some embodiments of the disclosed methods and apparatus, the value used for peer-reviewed musical skill level may default to a level that mimics the user's self-evaluated musical skill level and later change when other musicians provide data regarding the user's musical skill level. In some cases, the number of people the a user might have played with may be relatively small, so while it is possible to use statistical features to determine the peer review value (such as an average supplemented by a variance determined from the set of ratings provided by the user's peers), the rating can be determined simply to ensure that the rating is useful even with a relatively small sample size of peers.

Typically, the musical skill level ratings (both the user's self-evaluated musical skill level and the peer-evaluated musical skill levels) will be on a scale of 1-5, with “1” being the lowest skill level and “5” being the highest possible skill level. However, those skilled in the computer arts shall recognize that other skill level ratings can be used without departing from the scope of the disclosed methods and apparatus and the appended claims. For example, in some embodiments, the musical skill levels vary from 1 to 10, with “1” being the lowest possible skill level and “10” being the highest possible or most advanced skill level.

The present methods and apparatus also allow users to have multiple and different skill levels for multiple and different instruments. For example, a user might be a “4” (on a scale of 1-5) on the guitar, a “2” while singing (vocal skill level) and a “1” on harmonica. Rankings should be according to the concepts below. In some embodiments, this is not an all-encompassing definition of each level and it is purposely broad so that users performing at levels 1 through 3 need not become entangled in a competition. These musical skill and levels are selected solely so that other users/jammers can know what to expect when they meet new users/jammers.

In some embodiments, a user's musical skill ranking level will have a significant impact is if a jam is set up as an Experienced Jam or a Pro Jam. If a user is a beginner and is peer ranked lower on a particular instrument than the user's self-evaluation ranking on that instrument, the user likely needs to practice more on that instrument. If a user is an experienced musician/jammer (for example, if the user's self-evaluated ranking is a 4 or a 5 on a scale of 1-5) and the user receives lower peer rankings, it is an indication that the user may want to reconsider the user's self-evaluated ranking. By providing rankings of the user's ability, the present disclosed method and apparatus makes it possible for inexperienced players to find each other and enjoy a full and rich experience. In addition, more experienced players that want an opportunity to assist less experienced players can offer themselves to such less experienced players. In some cases, the more experienced players may be asked by the more experienced player(s) to pay a “lesson fee” for the opportunity to play with a musician from which the less experienced player can learn.

In some embodiments, a 5 point musical skill rating system is used in accordance with the description that follows. Those skilled in the musical and computer arts will recognize that other rating systems may be used to practice the presently disclosed methods and apparatus.

Beginner—Level 1—this level describes a user that is just thinking about or starting to play an instrument, which includes vocalists for whom their voice is their instrument. Beginners at Level 1 typically can play only one or two songs, or they cannot play an entire song. They typically do not know how to play more than a few chords, nor can they change playing different chords easily.

Intermediate—Level 2—this level describes a user that knows several songs, can play several chords and can move between these chords easily, and a musician that understands timing and counts.

Advanced—Level 3—this level describes a user that that can play many songs, understands the I-IV-V concepts, beginning to be able to play solo but is not yet proficient at it, is proficient in singing or playing backing roles, but is not yet able to lead a band (be a band leader) on stage.

Experienced—Level 4—this level describes a user that is proficient at the user's preferred type of music, has played in a band that has played on stage, knows many songs completely and understands many types of beats, feels and rhythms, etc. This type of user can lead a band or follow a band leader on stage, and has typically played for money or other valuable compensation.

Professional—Level 5—this level describes a user/musician that plays, or has played, for money or other valuable compensation, makes their living from playing music (or by selling instruments or by providing music lessons, or is in the music business).

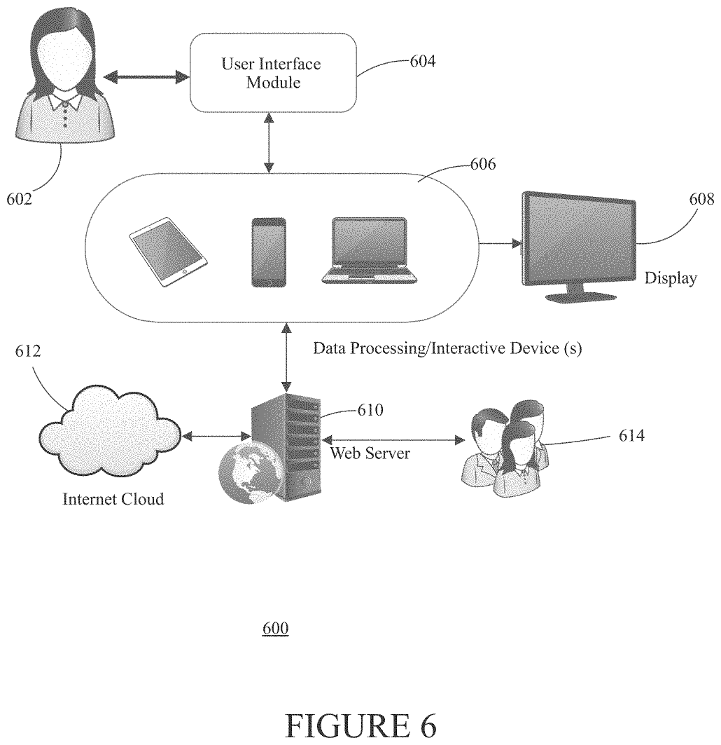

FIG. 6 is a simplified block diagram 600 of another embodiment of a system for assisting in the formation and development of relationships between different musicians and between musicians, and agents and managers of venues in which musicians might play music. As shown in FIG. 6, a user 602 enters and receives information to and from the system 600 using the User Interface Module 604. The User Interface Module 604 receives and enters information to and from one or more Data Processing/Interactive Devices such as the Data Processing/Interactive devices 606 shown in FIG. 6. As shown in FIG. 6, the Data Processing/Interactive Devices 606 may comprise a tablet, smart phone, a laptop, or desktop computing device. In some embodiments, the Data Processing/Interactive Devices 606 perform some of the functions described above with reference to FIGS. 1-5. In those embodiments, some of the functions described above may be executed by software executed upon data processors within the Data Processing/Interactive Devices 606. As shown in FIG. 6, the Data Processing/Interactive Devices 606 output data executed by the system 600 to a display 608. The display 608 is accessible to and by the user 602.

In some embodiments, such as the system shown in FIG. 6, the user's Data Processing/Interactive Devices 606 communicate with a Web Server 610. The Web Server 610 is in bi-directional communication with the user's Data Processing/Interactive Devices 606. In some embodiments, the Web Server 610 interacts with other users 614 of the system 600. In some embodiments, some or all of the methods described above are executed by software running on the Web Server 610. Alternatively, the methods described above are executed in combination and in cooperation with the user's Data Processing/Interactive Devices 606. In some embodiments, the Web Server 610 also is in bi-directional communication with an Internet Cloud 612. In these embodiments, the Internet Cloud 612 enables the system 600 to access additional information that is not locally available to the users 602, 614 of the system 600.

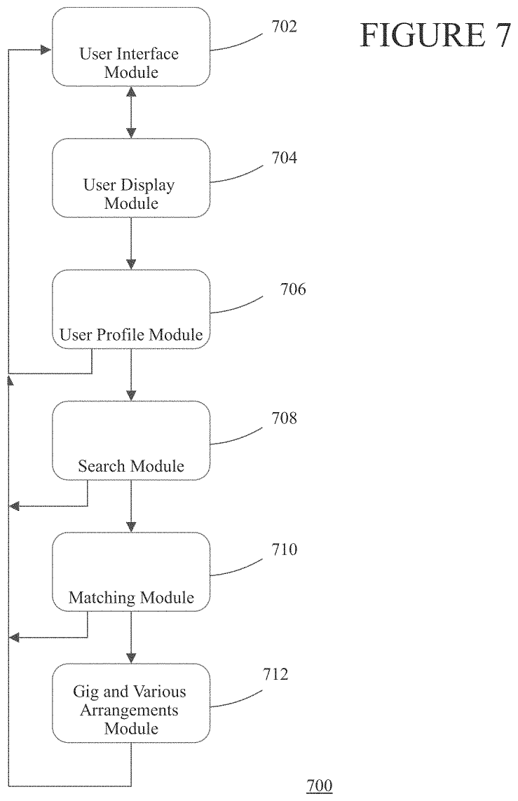

FIG. 7 shows a simplified block diagram 700 of execution modules designed to implement the presently disclosed methods and apparatus (for example, the above-described apparatus shown in FIGS. 1-2). As shown in the block diagram 700 of FIG. 7, in some embodiments of the presently disclosed methods and apparatus, the methods and apparatus include a User Interface Module 702, a User Display Module 704, a User Profile Module 706, a Search Module 708, a users' Matching Module 710, and a Gig Arrangement Module 212. As described above, in some embodiments, the user enters data into the system via the User Interface Module 702. The User Interface Module 702 is in bi-directional communication with the user. The User Interface Module 702 is also in bi-directional communication with the User Display Module 704. The User Display Module communicates information received from the User to the User Profile Module 706. The User Profile Module 706 communicates information about the User to both the User Interface Module 702 (for use by the user) and the Search Module 708. The Search Module 708 receives information from the user regarding the user's musical skill levels, desires for a gig, etc., as described above, and performs a search for like-minded musicians that use the system 700. The User Profile Module 706 also receives information regarding the User's Peer-reviewed musical skill level. As shown in FIG. 700, the Search Module may communicate its search results directly to the user via the User Interface Module 702, or the search results may be communicated to the Matching Module 710.

The Matching Module 710 may be invoked by the user via the User Interface Module 702 or via the User Profile Module 706 and Search Module 708. The Matching Module 710 communicates information regarding the search performed at the user's request directly to the user (via the User Interface Module 702). The Matching Module 710 may also communicate the matching results to the Gig Arrangements Module 712. The Gig Arrangements module 712 may then determine various rehearsal, gig, and other various musician-related gatherings at the user's request. The Gig Arrangements Module 712 communicates information provided by the other modules and possible gig and various other musician playing possibilities to the user via the User Interface Module 702.

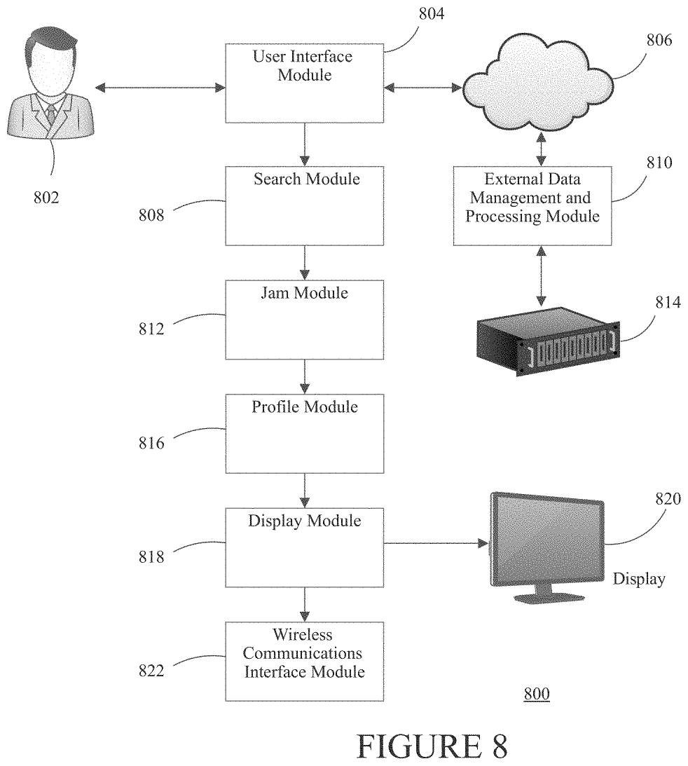

As noted above, in some embodiments, all of the modules (702, 704, 706, 708, 710, and 712) may be executed in software running on a processor present in one of the user's devices, in a Web Server (such as the Web Server 610 of FIG. 6), in an Internet Cloud (such as the Internet Cloud 612 of FIG. 6), or in a combination of those devices and apparatus. The present disclosures contemplate such obvious potential embodiments and therefore such variations in the embodiments of the presently disclosed musician matching apparatus and methods fall within the scope of the present disclosure and the appended claims. FIG. 8 shows yet another embodiment of a system designed to implement the presently disclosed methods and apparatus. The system shown in FIG. 8 does not depart much from the systems described above with reference FIGS. 1, 2 and 6, and therefore, is not described in much more detail herein.

As shown in FIG. 8, in some embodiments the system 800 includes a User Interface Module 804 in bi-directional communication with a User 802. The user 802 enters information pertinent to the system 800 via the User Interface Module 804. The User Interface Module 804 communicates with other modules such as the Search Module 808 and an internet cloud 806. The system 800 also includes a JMM 812, a Profile Module 816, a Display Module 818, and a Wireless Communication Interface Module 822. In some embodiments, such as that shown in the system 800 of FIG. 8, the system 800 includes external devices such as an External Data Management and Processing Module 810. In some embodiments the External Data Management and Processing Module 810 communicates with the Internet Cloud 806 and with an external system processor 814. The Display Module 820 displays results (such as search results or user matching results) on a display 820 which is accessible to and by the user 802.

As noted above, the system 800 and the modules and external devices implement functions similar to the methods and apparatus described above. Therefore, no further description is required to describe this additional exemplary embodiment 800 of the presently disclosed methods and apparatus for identifying and connecting musicians having diverse musical skill levels and interests.

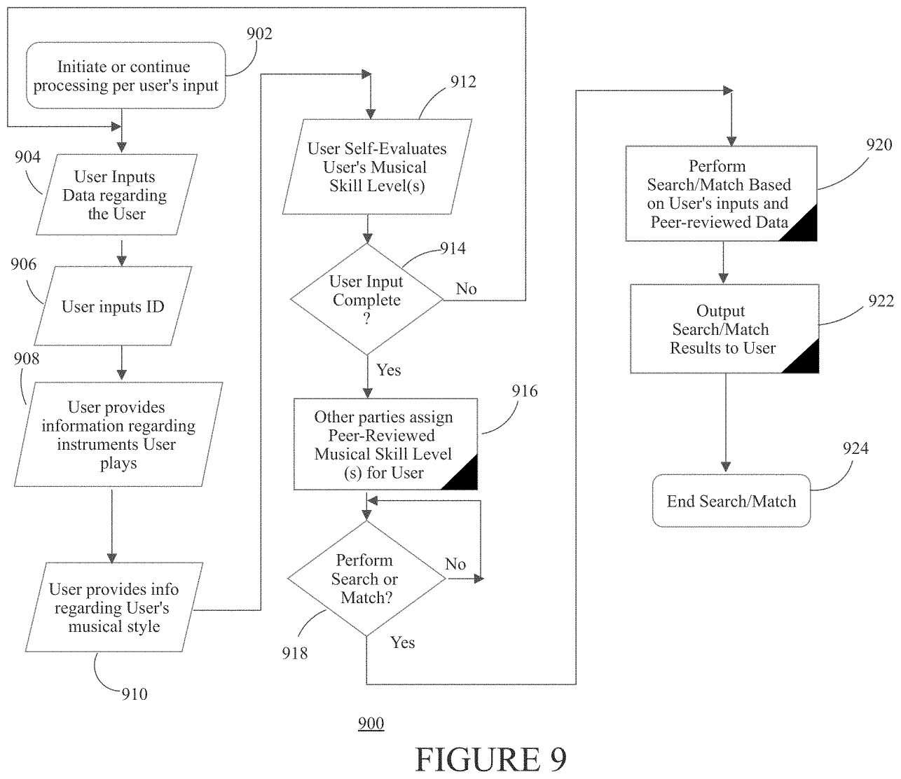

FIG. 9 is a flow diagram of a method 900 used to implement the presently disclosed methods and apparatus that permit users and musicians to evaluate their own and others musical skill levels and allow users to find, meet, and collaborate with other musicians of similar abilities, musical tastes, and desires for playing. The flow diagram 900 begins at an initial step 902 whereat processing is initiated in accordance to a user's commands. The method 900 continues to a data entry step 904. At the data entry step 904, the user enters information pertinent to the system and method, and more specifically, pertinent to the user's musical desires and proficiency (or proficiencies if applicable). The method continues to a step 906 whereat the user enters identification information for the user. The method then continues to a step 908 whereat the user provides information regarding instruments played by the user. The method next continues to a step 910 whereat the user enters information related to the user's musical style such as rap, country, rock, etc. Importantly, the method 900 then continues to a step 912 whereat the user provides information regarding the user's self-evaluated musical skill level. In some embodiments, as described above, the user self-evaluates the user's musical skill level on various instruments. This information is used by the methods and apparatus to accurately assist the user in obtaining the information desired by the user. The method 900 then continues to a decision step 914 to determine whether or not the User has completed entering information to the methods and apparatus. If not, the method 900 returns to the data entry step 904 for additional data to be provided by the user.

However, if the user has completed entering information, the method proceeds to a step 916 whereat the method obtains peer-reviewed assessment(s) of the user's musical skill levels on various instruments. As noted above, if no peer-reviewed assessments are available (because, for example, the user is new to the system or is new to this geographical area and no other user's have heard the user play), in some embodiments, the method may either assign a default level (such as, for example, a 3 on a scale of 1-5) for the peer-evaluated musical skill levels, or the system may simply use the user's self-evaluated skill level (s) for the default skill level (s). Different default skill levels fall within the scope of the presently disclosed methods and apparatus and the appended claims. The method 900 then continues to a decision step 918 whereat the method waits to determine if a search or match is to be performed. If a search or match is requested by the user, the method continues to an execution step 920 whereat a search or match is performed based upon the user's data entry and also based upon the peer-reviewed information related to the user. The method 900 then continues to an output step 922 whereat the search or matching results are displayed to the user. The method 900 then continues to a step 924 ending the method 900. The methods and apparatus can then return to the initial step 902 if the user desires additional information or if the user's desires or the user's musical skill levels change. If so, the method 900 is executed again starting at the initiation step 902.

### CONCLUSION

A number of advantages are offered by the present methods and apparatus for identifying and connecting musicians having diverse musical skill levels, abilities, and interests. The methods and apparatus use both the user's self-evaluated musical skill level(s) and peer-reviewed musical skill level(s) to make an accurate match or search. The methods and apparatus also allow managers, agents, and the like to match with musicians. Gigs and Jams can be arranged and used to connect musicians with like-minded other users and musicians.

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence). It will be evident that various modifications may be made to the disclosed examples of implementations without departing from the broader spirit and scope of implementations of the disclosure as set forth in the claims that follow. Where the disclosure refers to some elements in the singular tense, more than one element can be depicted in the figures and like elements are labeled with like numerals. The disclosure and drawings are to be regarded in an illustrative sense rather than a restrictive sense.

What is claimed is:

1. A method of connecting musicians having particular musical interests and abilities, the method accepting information from a user wherein the user enters one or more self-evaluated musical skill levels for the instruments the user plays, the method comprising:
(a) presenting input fields to the user into which the user enters data, whereas the data includes some if not all of the following information:
(1) the user's user identification (userID);
(2) one or more musical instruments that the user plays;
(3) the style of music the user is interested in playing; and
(4) the user's self-evaluated musical skill levels;
(b) obtaining one or more peer-evaluated musical skill levels for the user from other users, wherein the peer-evaluated musical skill levels are rated on the same scale as are the self-evaluated musical skill levels;
(c) matching the user with other musicians wherein the matching is performed, at a minimum, by accounting for the self-evaluated and peer-evaluated musical skill levels; and
(d) displaying a list of musicians and users with whom the user matches.

2. The method of claim 1, further comprising: receiving data from the user indicating a geographical location in which the user is available or desires to play, and whether the user is actively seeking to join a jam session with other musicians.

3. The method of claim 2, further comprising receiving from the user a distance the user is willing to travel from the location in which the user is available to play.

4. The method of claim 1, wherein the displayed other musicians are listed in order of a strength of match to the user.

5. The method of claim 4, further comprising: transmitting from a user device to an External Data Management and Processing Module (EDM) the user entered data and receiving within the user device a list of other musicians and other users determined by the EDM to match with the user.

6. The method of claim 5, further comprising: receiving from the EDM a match strength value (MSV) for each of the other musicians and other users indicating the strength of the match between the user and each of the other musicians and other users.

7. The method of claim 6, wherein each MSV associated with another musician or user is determined at least in part based on the user's self-evaluated musical skill levels and the peer-evaluated musical skill levels.

8. A musician connecting apparatus, connecting a user of the musician connecting apparatus to other musicians and users having particular musical interests and abilities, the musician connecting apparatus comprising:
(a) a User Interface Module wherein the User Interface Module accepts information from the user;
(b) a Search Module, coupled to the User Interface Module, wherein, upon command by the user, a search is performed designed to match the user's musical tastes, abilities, desires to perform or rehearse, and similar musical interests with those same qualities of other users of the musician connecting apparatus;
(c) a Jam Module, coupled to the Search Module, for generating jamming opportunities for the user based upon a user profile and search results provided by the Search Module;
(d) a Profile Module, coupled to the Jam Module and capable of receiving profile data entered by the user; wherein the Profile Module assists the user in creating a user profile, wherein the user profile contains at least the following information about the user:
(1) the user's user identification (userID);
(2) one or more musical instruments that the user plays;
(3) the style of music the user is interested in playing; and
(4) a user's self-assessment of the user's musical skill levels on one or more instruments based on a scale from beginner to professional; and
(5) one or more peer-evaluated musical skill levels provided by other users, wherein the self-evaluated and peer-evaluated musical skill levels use the same scale, from beginner to professional;
(e) a Display Module capable of outputting search and match results and other information to the user via a display; and
(f) a Wireless Communication Interface Module allowing the musician connecting apparatus to communicate with external devices.

9. The musician connecting apparatus of claim 8, further comprising:
(g) an internet cloud, wherein external devices and users may communicate with the musician connecting apparatus via the internet cloud, and wherein the internet cloud communicates with the user interface module;
(h) an External Data Management and Processing Module (EDM), wherein the EDM executes software to carry out search and match algorithms used by the musician connecting apparatus; and
(i) an Output Display, accessible to the user, for displaying matching and searching results and other information to the user.

10. The musician connecting apparatus of claim 8, wherein if a peer-evaluated musical skill level does not exist for the user, the musician connecting apparatus indicates that no peer-evaluated musical skill level for the user is currently available.

11. The musician connecting apparatus of claim 8, wherein a default peer-evaluated musical skill level is a “3” when the scale is from “1” indicating beginner, to “5” indicating professional.

12. The musician connecting apparatus of claim 11, wherein the default peer-evaluated musical skill is assigned to be identical to the user's self-evaluated musical skill level.

13. A method of connecting musicians having particular musical interests and abilities, the method accepting information from a user wherein the user enters one or more self-evaluated musical skill levels for the instruments the user plays, the method comprising:
(a) initiating processing of data received from a user, wherein the data may comprise one or more of the following:
(1) user identification (User ID) information;
(2) information regarding what instruments the user plays;
(3) a musical style or styles the user plays or desires to play;
(4) a user's self-assessment of the user's musical skill level for one or more instruments that the user plays;
(b) determining whether the user has completed entering the user's data and if so proceeding to (c), else returning to (a);
(c) entering peer-evaluated musical skill levels for the user for every instrument the user indicates that the user plays, or if no peer-evaluated musical skill level is available from other users, entering a default peer-evaluated musical skill level for the user;
(d) determining if a search or a match is to be performed matching the user with other users, and if not returning to (a), else proceeding to (e);
(e) performing a match or search based upon the data received from the user and the peer-evaluated musical skill levels received from other users; and
(f) displaying the search or match results, or both, to the user.

14. The method of claim 13, wherein the default skill level is an intermediate value indicating that the user defaults to an intermediate musical skill value whenever there is no additional information to be obtained regarding the user's peer-evaluated musical skill levels.

15. The method of claim 13, wherein the default value is equal to the user's self-assessed musical skill value whenever there is no additional information to be obtained regarding the user's peer-reviewed musical skill abilities.

16. The method of claim 13, further comprising providing information to the user regarding gigs, agents, venues, and other information based on the search and matching results produced by the method.

17. A musician connecting apparatus for connecting musicians having particular musical interests and abilities, the apparatus having a means for accepting information from a user, wherein the user enters one or more self-evaluated musical skill levels for the instruments the user plays, the method comprising:
(a) user input means for entering data received from a user of the apparatus, wherein the input may comprise one or more of the following input data:
(1) user identification (User ID) information;
(2) information regarding what instruments the user plays;
(3) a musical style or styles the user plays or desires to play;
(4) a user's self-assessment of the user's self-evaluated musical skill levels for one or more instruments that the user plays;
(b) a determining means, coupled to the user input means, for determining when the user has completed providing input data to the apparatus;
(c) peer-reviewed means, coupled to the determining means, for providing peer-reviewed musical skill values for the user for every instrument the user indicates that the user plays, and if no peer-evaluated musical skill level is available from other users, for entering a default peer-evaluated skill level for the user;
(d) search and matching means, coupled to the user input means, for performing a match or a search based upon the input data received from the user and based upon the peer-evaluated musical skill levels received from other users; and
(e) display means for displaying the search or match results, or both, to the user.

18. The musician connecting apparatus of claim 17, wherein if a peer-evaluated musical skill level does not exist for the user, the musician connecting apparatus assigns a default peer-evaluated musical skill level for the user.

19. The musician connecting apparatus of claim 18, wherein the default skill level is a “3” when the scale is from “1” indicating beginner, to “5” indicating professional.

20. The musician connecting apparatus of claim 18, wherein the default peer-evaluated musical skill level is assigned to be identical to the user's self-evaluated musical skill level.
